(19) United States
(12) Patent Application Publication
(10) Pub. No.: US 2002/0145129 A1
(43) Pub. Date: Oct. 10, 2002

(54) High luminance-phosphor and method for fabricating the same

(76) Inventors: Yun Sun-Jin, Taejon (KR); Kim Yong-Shin, Taejon (KR); Park Sang-Hee, Taejon (KR); Cho Kyoung-Ik, Taejon (KR); Ma Dong-Sung, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/116,247

(22) Filed: Apr. 3, 2002

Related U.S. Application Data
(63) Continuation-in-part of application No. 09/375,217, filed on Aug. 16, 1999.

(30) Foreign Application Priority Data
Aug. 14, 1998 (KR) 1998-33090
Jul. 5, 1999 (KR) 1999-26897

(51) Int. Cl. C09K 11/08; C09K 11/54

(52) U.S. Cl. 252/301.4 R; 252/301.4 S; 252/301.6 S; 252/301.6 R

(57) ABSTRACT

A phosphor emits blue color with high luminance and high color purity. The phosphor is fabricated by growing the host material of MX including a II group element (M=Ca, Sr, Zn, Ba or Mg) and a VI group element (X=S or Se) by reacting an M-precursor with a compound including the VI group element, and adding Pb²⁺ ions into the host material as light-emitting center ions by forming a PbX thin film through a surface saturation reaction between a Pb-precursor and H₂X at a reaction temperature higher than a decomposition temperature of the Pb-precursor, wherein the Pb-precursor is a metalorganic compound in which Pb is covalent-bonded with an organic functional group.

### CROSS REFERENCES TO RELATED APPLICATION

The present application is a continuation-in-part (CIP) application which claims the benefit of priority under 35 U.S.C. §120 from U.S. patent application Ser. No. 09/375,217 filed on Aug. 16, 1999 which, in turn, claims the benefit of priority under 35 U.S.C. §119 from Korean Patent Application Serial Nos. 98-33090 and 99-26897 filed on Aug. 14, 1998 and Jul. 5, 1999, respectively.

### FIELD OF THE INVENTION

The present invention relates to a method for fabricating a phosphor including Pb²⁺ ion as a light-emitting center ion, which is provided through a surface-saturating reaction by using Pb-precursors having covalent bond and inducing dimeric Pb²⁺ ions.

2. Description of Related Art

In general, a PbX (X=S or Se) thin film is effectively utilized as a phosphor in an electroluminescent device, a solar cell, and an infrared detector, etc. A conventional method for forming the PbX thin film and its drawbacks will be illustrated herein below.

Up to now, for the growth of the PbX thin film using atomic layer deposition or chemical vapor deposition, there has been used a reaction system in which PbS is grown either by the reaction of coordination compounds such as Pb(thd)₂ (thd=2,2′,6,6′-tetramethyl-3,5-heptandionate) and Pb(dedtc)₂ (dedtc=diethyldithio-carbamate) or halogen compounds such as PbCl₂, PbBr₂ having a +2 oxidation state of Pb (i.e., Pb(II) oxidation state) with H₂S or H₂Se, or by the decomposition of Pb(dedtc)₂ containing sulfur (S) (See, U.S. Pat. No. 5,496,597 issued at Jun. 20, 1994).

However, the coordination compounds such as thd-compounds show non-uniformity and bad reproducibility on the thin film growth. Furthermore, in case of the halogen compounds, halogen ions may reside in the thin film or on the surface for thereby causing a bad effect to the device fabrication and device characteristics. As a result, the device fabricated from the halogen compounds does not show good luminescence characteristics. In particular, when the Pb(thd)₂ is used for the fabrication of blue light-emitting electroluminescent devices, oxygen resides in the thin film thereby significantly decreasing the luminance.

In another conventional method for fabricating the PbS thin film, tetraethyl lead is reacted with a block copolymer matrix to thereby form an active site that reacts with H₂S to form a nanocluster of PbS. Since the polymer is regenerated in the course of reaction with H₂S, the size of the cluster can be continuously increased. Therefore, this method is not applicable to the deposition of a uniform PbS thin film and a phosphor thin film.

Another conventional method for fabricating the PbX thin film is to deposit single crystalline metal oxide or sulfide on a single crystal substrate at very low temperature using a metalorganic compound (See, U.S. Pat. No. 4,623,426 filed at Feb. 8, 1985). In this method, since alkyl, alkoxy or halide compound is not reacted with compounds containing sulfur or oxygen at a temperature lower than 300° C., it is reacted with very reactive atomic state (radical state) of oxygen or sulfur to deposit oxide or sulfide, wherein the radical of oxygen or sulfur is generated by decomposing the compounds containing sulfur or oxygen through the use of a light source. This method is directed to the growth of an epitaxial thin film at a lower temperature.

Meanwhile, when a transition metal element, a rare earth metal element or the like is added as a light-emitting center ion into host materials of compounds consisted of II group element and VI group element in the periodic table (hereinafter, referred to as II-VI compounds), the metal-doped materials can be used as a phosphor which is luminescent in a region of red, blue and green visible light.

Hereinafter, there will be described the general characteristics of the phosphor, existing methods for fabricating such a phosphor and their problems.

There are several mechanisms by which the phosphor produces luminescence. At first, in case of the electroluminescent device, electrons are injected from a boundary surface between the phosphor layer and an insulating layer into a phosphor layer at the time of applying an electric field to both ends of the insulating layer surrounding the phosphor layer. Then, the electrons are accelerated to impact against light emitting center ions in the phosphor layer, so that electrons of the light emitting center ions are excited from a ground state to an upper energy level by the impact. When the electrons of the ions come back from the excited energy level to the ground state, luminescence is generated with energy corresponding to a difference between the two energy levels.

In case of a field emission display (FED), luminescence is generated through processes that electrons, which are emitted into vacuum from an electron tip or electron source, are accelerated to impact against light-emitting center ions in the phosphor layer to thereby excite electrons of the ions. This luminescence principle is called as a cathodeluminescence (CL). Photoluminescence (PL) phenomenon is the case that the energy source exciting the light-emitting center ions is not electrons but light or photon. The phosphors generating bright light through such mechanisms are used in information displays.

As one example of the displays, the electroluminescent device has many advantages in durability against environmental attack such as vibration and impact, a very wide operating temperature range, a wide viewing angle and a short response time. However, although the luminances of red and green light were very high, the luminance of blue light was low. As a result, there has been a limitation in the prior devices that full-color with excellent quality could not be implemented. It is considered that one of the reasons of the limitation is that in the energy transition process for the blue light emission, the energy levels of the blue light-emitting center ions are more affected by impurities or undesirable chemical states than those of the red or green light-emitting center ions, since the wavelength of the blue light is short, i.e., the transition energy is high.

Furthermore, it is necessary to develop red and/or green phosphors with high color purity together with a blue phosphor according to application purposes of display devices. However, there has been a limitation in the fabrication of the phosphors with high luminance and high color purity.

As a general phosphor thin film in the field of blue electroluminescent device, ZnS:Tm (Tm compound doped into ZnS host material) has been studied for several decades. However, the phosphor exhibited a luminance lower than 1 cd/m² at a driving frequency of 1 kHz. Therefore, the fabrication of the blue phosphor has been considered as the most difficult technical problem in this field because the luminance of the blue phosphor was much lower than those of the red and green phosphors.

Recently, it has been reported that a phosphor of thiogallate compounds such as CaGa₂S₄ and SrGa₂S₄ has a luminance of about 12 cd/m² at a driving frequency of 60 Hz. In case of the thiogallate compounds, however, it is impossible to deposit by the atomic layer deposition since Ga in the thiogallates grown by the atomic layer deposition does not have a proper oxidation state for electroluminescence. The fact that a Ga source material is very expensive is another serious drawback in the fabrication of electroluminescent devices.

As a result of the study for the Pb-doped CaS (CaS:Pb) phosphor thin film, E. Nykanen et al. in Finland reported the use of coordination compounds such as Pb(thd)₂ and Pb(dedtc)₂ and halogen compounds having a Pb(II) oxidation state as a Pb-precursor in Electroluminescence Workshop (May, 1992, p.199). The electroluminescent device has maximum luminance 2.5 cd/m² at a driving frequency of 300 Hz. Moreover, an ultraviolet ray was emitted dominantly when the concentration of Pb²⁺ ions was very low. When the concentration was below 1.0 mol %, there were observed an ultraviolet ray and blue luminescence simultaneously. The blue luminescence was observed only in a concentration range of 1.0 to 1.5 mol %, and the CIE color coordinate of the best blue color was (0.13, 0.17). The result of the study showed that the color was gradually shifted to green as the concentration of Pb²⁺ ions increased. As a result, it is noted that the EL showing the blue color was observed only in the concentration range of 1.0 to 1.5 mol % and had a luminance lower than 1 cd/m² at a driving frequency of 60 Hz.

Another example of growing the Pb-doped CaS phosphor of the electroluminescent device is that CaS is mixed with PbS or Pb metal to produce a solid source material and the material is deposited on a substrate by a electron beam evaporation method (See, D. Poelman et al., J. Phys. D.:Appl. Phys. 30, 1997, 445). However, it is reported that the characteristics of the phosphor film are very poor and it cannot be used for a blue light-emitting phosphor material due to a clustering of PbS that causes the red shift of the emitted light and degradation of emission. In this case, it showed a luminance lower than 1 cd/m² at a driving frequency of 20 kHz. This value corresponds to a very low luminance according to a general trend in which the luminance increases as the driving frequency increases. Particularly, the document reported that the blue emission could be obtained only in case of a Pb²⁺ ion concentration of below 1.0 mol % because of the clustering.

It has been reported that the poor results were shown similarly even in the phosphors of SrS:Pb, SrSe:Pb and the like, i.e., the emission wavelength was changed depending upon the Pb concentration, and the luminance at a room temperature (300K) was very low (See, N. Yamashita et al., J. Phys. Soc. Japan, 53, 1984, pp.419-426).

To ameliorate the drawbacks associated with the techniques described above, there have been proposed several devices. One of such devices is disclosed by the same inventors of the present invention entitled “High-Luminance Blue-Emitting CaS:Pb devices Fabricated Using Atomic Layer Deposition”, SID 99 DIGEST. This device, high-luminance blue light emitting CaS:Pb electroluminescent device, is fabricated by using the atomic layer deposition, wherein the luminance, L₂₅, exceeds 80 cd/m² at the driving frequency of 60 Hz and the CIE color coordinate ranging from (0.14, 0.07) to (0.15, 0.15) is almost identical to that of the blue of a cathode ray tube. The CIE color coordinate range is determined according to an adding condition of Pb²⁺ ions. The other device is disclosed by the same inventors of the present invention entitled “Blue-Emitting Pb-doped Calcium Sulfide Electroluminescent Devices Grown Using Tetraethyl Lead as Pb-Precursor”, Asia Display 98/IDRC. However, the result reported in 1998 had a poorer characteristic more than 40 times compared to the result reported in 1999 since its fabricating condition was not optimized. The blue-emitting CaS EL device is grown by using the atomic layer deposition, wherein tetraethyl lead is first used as a Pb-precursor in the growth of CaS:Pb, which is a metalorganic compound containing no oxygen. The result demonstrates that CaS:Pb can be a promising blue phosphor for a bright full color EL device. The EL spectrum revealed an intense peak at the wavelength of 445 nm indicating pure blue emission. The luminance, L₆₀, of 3,000 Å thick CaS:Pb (0.3 at. %) phosphor having a non-optimized structure for maximum luminance is 32 cd/m² at a driving frequency of 1 kHz.

However, there is still a demand for providing a phosphor exhibiting high luminance and highly pure color, and a fabricating method thereof.

### SUMMARY OF THE INVENTION

To overcome the problems of the prior arts, the present invention provides a method for fabricating a phosphor using a stable liquid precursor, which saves the cost in view of materials, time consuming and labor force.

Another object of the present invention is to provide a method for fabricating a phosphor exhibiting high luminance and highly pure color by adding PbX (x=S or Se) to host materials of II-VI compounds.

In accordance with an embodiment of the present invention, there is provided a method for fabricating a PbX (X=S or Se) thin film, in which the PbX thin film is formed by the reaction between a Pb-precursor and H₂X (X=S or Se). Here, the Pb-precursor is a metalorganic compound in which Pb is covalent-bonded with an organic functional group. It is preferred that the PbX thin film is formed at a temperature of 150 to 500° C. by an atomic layer deposition (ALD) or chemical vapor deposition (CVD) method. The Pb-precursor may include tetravalent lead compounds such as tetraalkyl lead and tetraaryl lead, and tetravalent lead compounds having alkyl and aryl groups such as alkyl-triaryl lead, dialkyl-diaryl lead and trialkyl-aryl lead. The Pb-precursor may also include divalent lead compounds such as dicyclopentadienyl lead and bis(trialkyl)silyl lead. In the above, the alkyl group may include methyl, ethyl, propyl, isopropyl and cyclohexyl groups and the aryl group may include phenyl and benzyl groups.

More specifically, the PbX thin film has been grown by using coordination compounds of Pb(II) as the Pb-precursor in the prior arts. However, in the present invention, the PbX thin film is formed by using tetravalent metalorganic compounds of Pb(IV) (e.g., tetraalkyl lead or tetraaryl lead) or a divalent metalorganic compound of Pb(II) (e.g., dicyclopentadienyl lead) as the Pb-precursor through a surface saturation reaction occurring in the atomic layer deposition or chemical vapor deposition. As a result, the inventive PbX thin film shows good uniformity in a thickness due to the stability of the Pb-precursor. The PbX is grown as a very stoichiometric and polycrystalline film of high crystallinity.

In accordance with the present invention, there is provided a method for fabricating a phosphor including a host material, which contains light-emitting center ions directly attributed to the light-emitting by being impacted with accelerated electrons. In the present invention, the phosphor is manufactured by separately and alternately executing the growth reaction of the host material and the growth reaction of light-emitting ions. Herein, the metalorganic compound including Pb covalent-bonded with the organic functional group as described above is used as the Pb-precursor and the Pb-precursor is reacted with H₂X (X=S or Se), thereby inserting PbX into the host material. As a result, the method for fabricating the phosphor in accordance with the present invention provides the phosphor exhibiting high luminance and highly pure color.

In the phosphor fabricating method in which the PbX is inserted into the host material by adsorbing the metalorganic Pb-precursor on a surface of the host material and providing H₂X compounds on the adsorbed Pb-precursor to execute the surface saturation reaction between the Pb-precursor and the H₂X compounds, the light-emitting center ions, i.e., Pb²⁺ ions, can be controlled to exist as a Pb²⁺ dimer type in the grown PbX. As a result, the phosphor can be obtained to exhibit the high luminance and highly pure color regardless of the concentration of Pb²⁺ therein under a condition of the Pb concentration range of 0.2 mol % to 4.0 mol % (this range is much wider than those of the prior arts). But, in order to obtain a blue phosphor having high luminance, the fabricating method should be performed according to following conditions.

At the time of the deposition of II-VI compounds such as CaS, CaSe, SrS, SrSe, ZnS, ZnSe, BaS, BaSe, MgS, MgSe, and the like, if the PbX is inserted into the host material by the method described above, the resulting product can act as a phosphor. At this time, if selectively growing the PbX to dominate the light-emitting caused by the dimer type, i.e., forming the Pb-precursor as a dimer type intermediate which is adsorbed on the growth surface in the dimer type of PbX, the phosphor can be manufactured to exhibit constant color at a wide concentration range. The growth rate of the PbX is preferably 0.005 to 0.6 Å/cycle. In this case, if the growth rate is higher than 0.6 Å/cycle, dimers are neighbored to other dimers to produce bigger aggregates, resulting in the deterioration of the color purity.

In case of PbS, since the sizes of Pb²⁺ ion and S²⁻ ion are 1.2 Å and 1.8 Å, respectively, a thickness of one layer of PbS becomes approximately 3.0 Å. Therefore, the growth rate 0.005 Å/cycle means that the PbS is deposited only on a region corresponding to 0.2% of a whole surface in one cycle for the PbS growth and the growth rate 0.6 Å/cycle represents that the PbS is grown only on a region corresponding to 20% of the whole surface in one cycle. In general, in a process of growing a thin film by using a thin film deposition method, when the thin film is grown thinner than the one layer, i.e., its surface coverage is less than 1, it could be converted to the thickness as shown above. If a film thickness grown during n cycles (or unit time) is m Å, the growth rate can be represented as (m/n)(Å/cycle) or (m/n)(Å/unit time). In the present invention, the thickness is used corresponding to the growth rate determined as above.

As will be described in the detailed description of the present invention, in order to form the PbX in the dimer type maintaining Pb-Pb bonds in the host material of the phosphor, the PbX may be formed at a temperature of 150 to 500° C. by the atomic layer deposition which is executed by the surface saturation reaction. Here, “A” (Å/cycle) is a growth rate of the host material and “B” (Å/cycle) is a growth rate of the PbX. Then, “a” cycles of the host material growth reactions and “b” cycles of the light-emitting ion growth reactions are performed to form the host material film of a×A Å and the light-emitting ion film of b×B Å, respectively. Herein (a×A) Å of the host material film and (b×B) Å of the light-emitting ion film are alternately grown N times, thereby growing the phosphor thin film of [N×(a×A+b×B)] Å. At this time, the “B” is preferably 0.005 to 0.6 Å/cycle and the “b” is preferably 2 or less.

Conventionally, in case of applying the atomic layer deposition whose reaction rate is adjusted by the surface reaction, it has been known that the precursor should not be self-decomposed in a gas phase at the reaction temperature (See, T. Suntola, Materials Science Reports Vol. 4, No. 7, 1989, p. 283). Therefore, in the growth of the PbX by the atomic layer deposition in accordance with the prior arts, Pb(II) compounds whose decomposition temperature is higher than the reaction temperature and which have a +2 oxidation state like the host material, such as thd- and dedtc-coordination compounds and halogen compounds have been used as the Pb-precursor. However, in accordance with the present invention, the thin film having an excellent growth reaction and film properties can be grown at a temperature substantially higher than the decomposition temperature by using the metalorganic compound precursor including tetravalently boned Pb. Herein, the decomposition temperature represents a temperature at which a compound starts to be decomposed.

As one example, in accordance with the present invention, in case of using, as the Pb-precursor, tetraethyl lead that is boiled at 198° C. under an atmosphere pressure and is partly decomposed at a temperature of above 110° C., a very uniform PbS thin film can be grown even at a reaction temperature of above 300° C. The reason is that the tetravalent Pb-precursor is partly decomposed to form an intermediate which is chemical species having a form advantageous for forming the dimer type PbS of the +2 oxidation state.

Meanwhile, in the conventional phosphor fabricating method, the Pb²⁺ ion added in the form of PbS or PbSe into the host material of II-VI group compounds such as CaS, CaSe, SrS, SrSe, ZnS, ZnSe, BaS, BaSe, MgS and MgSe has the same cubic crystalline structure and oxidation state as the host material. Thus, the Pb²⁺ ion is added into the host material and easily substituted with elements of the host material without a charge compensator added. As a result, the Pb²⁺ ion is formed as a cluster or aggregate as well as a monomer. This is proved by an experimental fact that in PL research results for CaS:Pb²⁺, CaSe:Pb²⁺, SrS:Pb²⁺, SrSe:Pb²⁺ and the like, excitation spectra and emission spectra are different from each of the research results; several peaks appear superimposed; and any specific energy transition does not account for the spectra (See, S. Asano, N. Yamashita, and Y. Nakao, Phys. Stat. Sol. (b)89, 663(1978)). For instance, in case of CaS:Pb²⁺, the variation of the spectrum according to Pb²⁺ concentrations was observed in order to study the state of monomer. As a result, the Pb²⁺-monomer showed emission in an ultraviolet region and the wavelengths were 355 and 364 nm for CaS:Pb and 371 and 380 nm for CaSe:Pb. Furthermore, the PL peaks were gradually moved to a longer wavelength as the concentration increased. However, according to the above reference document, it was impossible to manufacture materials selecting and only emitting light having a certain specific wavelength regardless of the concentration.

In case of CaS:Pb phosphor, the radius of Pb²⁺ ion is 1.20 Å and the radius of Ca²⁺ is 0.99 Å. Therefore, there is about 20% of lattice mismatch between Pb²⁺ ion and Ca²⁺ ion. As a result, if a large amount of Pb is added into the host material, the crystalline is degraded to deteriorate EL (electroluminescence) and CL (cathodeluminescence) characteristics regardless of the clustering of Pb²⁺ ions. Therefore, the present invention provides the MX:Pb (M=Ca, Sr, Zn, Ba, Mg; X=S, Se) compound phosphor in which Pb²⁺ ions exist in a specific state to emit one color regardless of their concentration within a preset concentration range and which can produce emission of EL or CL in a certain wavelength region not to degrade the crystallinity of the host material. The present invention can enhance the luminance and color purity of the phosphor.

In case of SrS:Pb²⁺, the monomer shows emission in 368 nm and the dimer does it in about 500 nm. Further, even in case of SrS:Pb, the present invention provides the electroluminescence with a single peak in about 500 nm unlike the prior researches.

Moreover, the phosphor manufactured by the present invention can be applied to electroluminescent devices, enhancing the characteristics of the electroluminescent device. The structure of the electroluminescent device includes both of a general structure and an inverted structure utilized in an active matrix and the like. And also, the phosphor of the present invention can be applied to a PL and a CL phosphor.

### BRIEF DESCRIPTION OF THE DRAWINGS

The above and other objects and features of the present invention will become apparent from the following description of preferred embodiments given in conjunction with the accompanying drawings, in which:

FIG. 1 is a sectional view showing layers containing light-emitting center ions added into a host material of a phosphor;

FIG. 2 schematically shows a traveling wave reactor type equipment as an example of an equipment for the atomic layer deposition in accordance with the present invention;

FIG. 3 is spectra showing EL peaks of CaS:Pb phosphors having different concentrations of Pb²⁺;

FIG. 4 is spectra showing the variation of EL peaks as increasing a thickness of a layer containing the light-emitting center ions of FIG. 1;

FIG. 5 illustrates a spectrum comparing a cathodeluminescent (CL) peak of CaS:Pb phosphor having 0.7 at. % Pb²⁺ ion concentration with that of a conventional ZnS:Ag phosphor;

FIGS. 6A and 6B show structures of an alternating current driven thin film electroluminescent device (AC-TFELD) grown on a transparent substrate and an inverted structure grown on a non-transparent substrate, respectively;

FIG. 7 is a luminance-voltage curve showing a luminance of a CaS:Pb blue electroluminescent device fabricated by the atomic layer deposition in accordance with the present invention; and

FIG. 8 provides spectra showing electroluminescence characteristics of CaS:Pb blue electroluminescent devices fabricated by using Pb(thd)₂ and tetraethyl lead as a Pb-precursor, respectively.

### DETAILED DESCRIPTION OF THE INVENTION

The invention will be illustrated in detail by the following preferred embodiments with reference to the accompanying drawings.

Pb²⁺ ion has a 6s² state of the valence electron configuration in a ground state. When the Pb²⁺ ion absorbs energy, the electron of the Pb²⁺ ion transits to a 6s¹6p¹ state. Then, when the excited electron comes back from the excited state to the ground state, emission occurs. The states of the energy levels are quite affected by the states of ion and an ambient host material.

This embodiment relates to a CaS:Pb blue phosphor and a method for fabricating the same, in which most Pb²⁺ ions selectively exist in a CaS or CaSe host material as in a dimer state suitable to emit luminescence of blue color, thus, the phosphor can emit luminescence with high luminance and high color purity. For reference, it is well known that general blue phosphors become lower in the luminance as going close to pure blue color. In case of SrS:Cu,Ag blue phosphors grown by a magnetron sputtering method, the luminance tended to become lower as a plenty of Ag was doped in the host material and, thus, the color moved to pure blue color.

In the method for fabricating the phosphor, there is simply described, as below, processes to control a chemical state of Pb ion finely and to grow the MX:Pb phosphor, in which PbX is added small amounts into MX host materials (here, M=Ca, Sr, Ba, Zn or Mg; X=S or Se). In order to dope PbX into the MX host material, first, the MX compound is grown with a certain thickness and, subsequently, PbX is grown with a certain thickness to satisfy a desirable concentration. Then, the growth processes are repeated. At this time, one time growth thickness of the MX layer and one time growth thickness of the PbX on the MX layer are determined depending upon the desirable concentration of Pb²⁺ ion and the growth rates. The basic concept of such growth method utilizing a surface saturation reaction is called as the atomic layer deposition or atomic layer chemical vapor deposition. The surface saturation reaction means that, when a reactive material is boned on a surface of a substrate, the reactive material is primarily bonded on a bondable portion of the surface of the substrate without missing parts and, then, it is bonded on other portions including previously bonded materials.

In accordance with an embodiment of the present invention, a phosphor and a method for fabricating the same are described below. The phosphor is formed by adding PbS to CaS and includes most of Pb²⁺ ions existing in a dimer form.

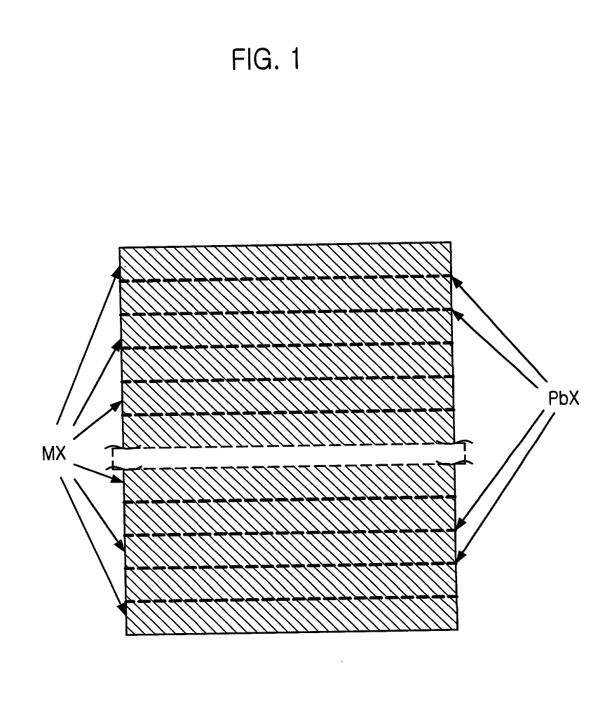

As shown in FIG. 1, when growing CaS through “a” cycles of reactions and growing PbS through “b” cycles of reactions are performed in turn, and the processes are repeated N times, the thickness, T, of CaS:Pb compound phosphor thin film may be represented by a following equation, EQ. 1.

T={(a×A)+(b×B)}×N EQ. 1

Herein, A and B are the growth rates (Å/cycle) of CaS and PbS, respectively, and may be thinner than one layer of MX or PbX. For the convenience, the A and B are represented as being converted to a thickness as described above.

The growth rate varies according to the size of a Pb-precursor and a degree of being adsorbed on the surface and being detached from the surface. When growing the film by using the atomic layer deposition method, it is often to find cases that the growth rate is less than the one layer thickness.

The concentration of Pb²⁺ ions, C, is represented by a following equation, EQ. 2.

C(mol %)=(b×B)/{(a×A)+(b×B)} EQ. 2

The Pb²⁺ ions can be doped with a desirable concentration by controlling the ratio of cycles. The present invention can selectively grow Pb²⁺ ions so as to emit dominantly luminescence from the dimer state in a concentration range maintaining excellent crystallinity unlike the prior arts in which Pb²⁺ ions are doped with different states according to Pb concentrations. That is, the present invention controls the growth of PbS not to form aggregates larger than Pb²⁺-dimer.

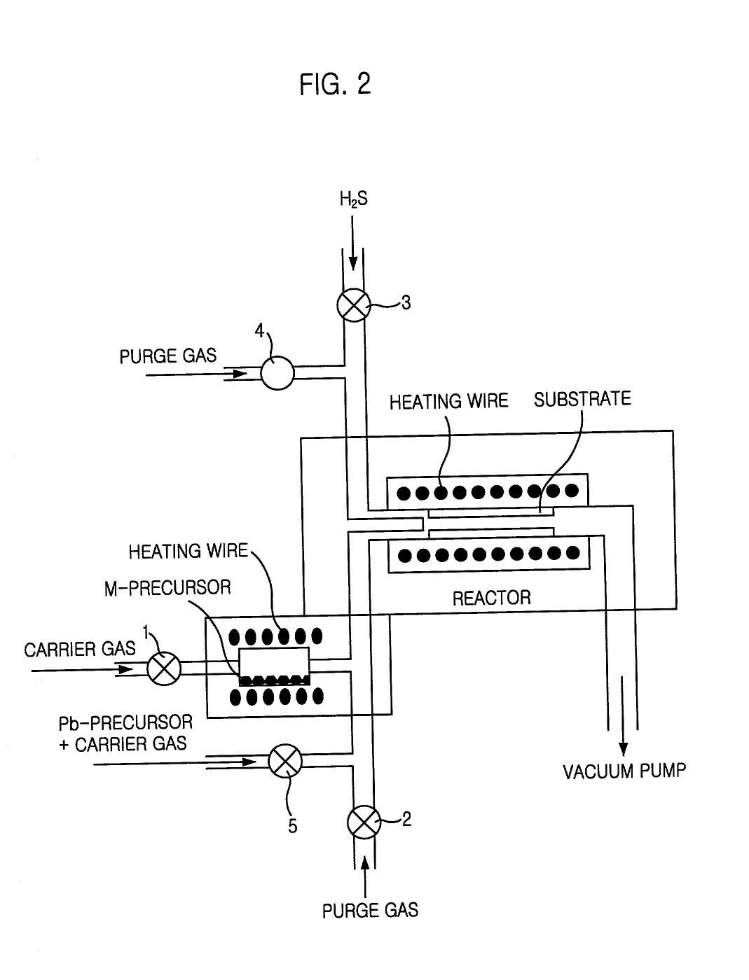

FIG. 2 schematically shows a traveling wave reactor type equipment for used in the atomic layer deposition in accordance with the present invention.

The atomic layer deposition (ALD) is a technique using a surface chemical reaction on the surface of a substrate. As an example, there are described below processes for depositing II-VI metal sulfide doped with PbS using M-precursor (M=Ca, Sr, Zn, Ba or Mg), H₂S and Pb-precursor.

As another example, the chemical vapor deposition (CVD) method is performed for the growth of a metal sulfide (MS) host material by injecting two or more precursors simultaneously and ALD method is executed for the growth of PbS so as to grow the PbS through the surface reaction. These two deposition methods can be performed repeatedly. However, in case of ALD, the valves 1 to 5 shown in FIG. 2 are controlled independently without simultaneously opening two or more valves according to the following sequence.

The valve 1 is opened to inject M-precursor vapor with a carrier gas. This allows the M-precursor reactant to be adsorbed on the surface of a substrate.

The valve 2 is opened to inject nitrogen or inert gas. This allows the unabsorbed residues of the M-precursor reactant to be removed.

The valve 3 is opened to inject H₂S gas. The H₂S reacts with the M-precursor reactant adsorbed on the surface of the substrate to grow an MS thin film. In this process, volatile side-products are generated.

The valve 4 is opened to inject nitrogen or inert gas. This allows the extra H₂S molecules and the volatile side-product of the reaction between the M-precursor and H₂S to be removed.

The processes 1) to 4) are repeated several to several tens of cycles.

The valve 5 is opened to inject Pb-precursor. This allows the Pb-precursor to be adsorbed on the surface of the MS.

Nitrogen or inert gas is injected to remove the unabsorbed residues of Pb-precursor.

H₂S is injected to surface-react with the Pb-precursor adsorbed on the substrate. At this time, a PbS thin film is formed and volatile side-products are generated.

Nitrogen or inert gas is injected to remove the extra H₂S and the volatile side-products produced by the reaction between the Pb-precursor and the H₂S.

The processes 6) to 9) may be optionally repeated along with two or more cycles.

The processes 1) to 10) are repeated to get the desired total thickness of MS:Pb

Since the ALD method is performed with the above processes, it can grow the thin film with a deposition rate of below 1 monolayer/cycle and finely control the composition of the MS:Pb thin film by controlling the number of the repeating cycle. The monolayer means one layer of a certain compound such as MX or PbX. Meanwhile, since the CVD method controls the composition of the thin film by controlling the relative concentration ratio of the precursors, it is more difficult in the CVD to control the states of light-emitting center ions than in the ALD.

In the prior arts, the emitted colors of the phosphors are gradually changed according to the concentration of Pb²⁺ ions in the phosphors. It is considered that the Pb²⁺ ions exist in a monomer state at a low concentration, and the number of Pb²⁺ dimers is increased gradually as increasing the concentration of Pb²⁺ ions and coexists with the monomer. Then, the cluster of Pb²⁺ ions is formed at above a certain concentration and becomes to emit luminescence of green color. It is reported that the luminances of the phosphors of the prior arts are low due to the cluster. However, the present invention can allow Pb²⁺ ions to be in the dimer state regardless of the concentration.

In order to grow Pb²⁺ ions only in the dimer state regardless of the concentration, it is necessary to use a reactant precursor having specific properties. There is provided a tetraethyl lead as an example. This compound exists as the tetraethyl lead at a room temperature, but starts to be decomposed at a temperature above 110° C. It is also easily decomposed in a reactor maintained at a reaction temperature of 200° C. or higher. At this time, Pb₂(C₂H₅)₆ (hexaethyl dilead) is formed with high possibility. Since a Pb—Pb bond is stronger than a Pb—C bond, Pb is adsorbed in the dimer state on the reaction site of the surface. This is supported by a fact that Pb₂(C₂H₅)₆ is generated at a synthesis reaction using the tetraethyl lead. In consideration of the property of Pb to aggregate each other, this reaction should be performed with a low growth rate so as not to adsorb another Pb at the nearest neighbor site of Pb, e.g. 0.2 monolayer/cycle or less. Pb may be doped only in the dimer state if the doping is performed with the above growth rate. If the migration tendency of Pb is higher, the growth rate should become lower.

After the growth reaction of the host material is performed several to dozens of cycles, the growth of PbX may be also isolatedly inserted one cycle between the growth cycles of the host material. This allows the inserted dimer of Pb²⁺ ions not to form the cluster or aggregate. As a result, it is possible to form a phosphor capable of emitting luminescence generated only from the dimer. This effect appears predominantly above a specific temperature according to a temperature deviation of the growth equipment and the kind of the reaction precursor.

Precursors having the similar reaction property as the tetraethyl lead used in the above embodiment include tetraalkyl lead precursors containing methyl, ethyl, propyl, isopropyl, and cyclohexyl groups as an alkyl group, and tetraaryl lead precursors containing phenyl and benzyl groups as an aryl group, e.g., tetraphenyl lead, tetracyclohexyl lead, triphenylbenzyl lead, diphenyldicyclohexyl lead, dicyclopentadienyl lead and so on. Other precursors having the similar reaction property as these compounds may be available as the same use.

There is described in this embodiment that Pb²⁺ ions mostly exist in the dimer state at a specific condition and only one peak of luminescence is generated from the dimer state. This embodiment of the present invention relates to a CaS:Pb electroluminescent device, which can emit the luminescence of highly pure blue color regardless of the concentration of Pb²⁺ ions within the concentration range of 0.6 mol % to 4.0 mol %.

In the process for growing PbS by the reaction of the tetraethyl lead with H₂S after the growth of CaS using Ca(thd)₂ (thd=2,2′,6,6′-tetramethyl-3,5-heptandionate), the total concentration of Pb²⁺ ions can be determined by controlling the repeating ratio in consideration with the growth rate of PbS at 320° C. being 0.01 Å/cycle, at 400° C. being 0.15 Å/cycle and the growth rate of CaS being 0.35 to 0.45 Å/cycle. Since the growth rate of PbS is 0.15 Å/cycle or less at 400° C. or less, the surface coverage per cycle is 0.1 or less. Namely, one or less among ten of the available reaction sites is bonded with PbS. Therefore, the formation of aggregate is suppressed by controlling the cycle number of the PbS growth. FIG. 1 schematically shows a sectional view of the MX:Pb thin film grown by such a method. As shown in FIG. 1, the PbS doped by the above method is uniformly distributed in the CaS host material in the dimer state not a continuous film state.

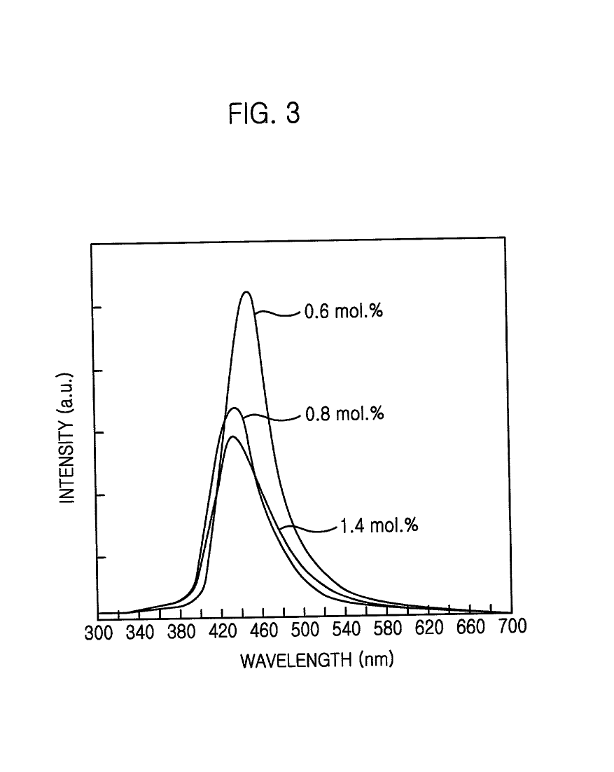

Controlling the respective growth cycle number “a” and “b” of CaS and PbS to grow the phosphor thin film allows Pb²⁺ ions to be in the dimer state regardless of the concentration of Pb²⁺ ions. Table 1 and FIG. 3 show that the CaS:Pb phosphor thin film of the embodiment has the characteristics to emit the luminescence of constant wavelength and color coordinate.

Table 1 shows the color coordinate of the phosphor thin film fabricated as maintaining PbS cycle number as 1 (that is, the thickness of PbS added at one time is 0.15 Å) and decreasing the cycle number of CaS at 400° C.

The color coordinate at about 0.6 mol % of PbS concentration was almostly the same as that at about 2.5 mol % and the luminance was changed only a little. In Table 1, the “x” value is a red-included ratio in the luminescence and the “y” value is a green-included ratio. Therefore, a blue-included ration corresponds to 1-x-y.

TABLE 1

| | |
|---|---|
| Pb concentration | CIE color coordinate |

| (mol %) | x | y |
|---|---|---|
| 0.6 | 0.15 | 0.11 |
| 0.8 | 0.14 | 0.10 |
| 1.0 | 0.15 | 0.11 |
| 1.4 | 0.15 | 0.10 |
| 2.0 | 0.15 | 0.11 |
| 2.5 | 0.14 | 0.12 |

FIG. 3 shows EL spectra of EL devices including phosphor thin films with 0.6 mol %, 0.8 mol %, and 1.4 mol % of Pb²⁺ ion concentration. As shown in FIG. 3, the peaks of the spectra appear at the almost same wavelength though the difference between the concentrations of Pb²⁺ ions is above 2 times. Particularly, the spectra of the present invention show a single peak having a narrow width unlike those of the prior arts showing several EL peaks to be partly superimposed with a wide width.

The results of Table 1 and FIG. 3 mean that the present invention fabricated the phosphor material selectively including the dimer state of Pb²⁺ ions regardless of the Pb²⁺ concentration unlike the prior arts obtained blue EL under a narrow region of Pb²⁺ concentration (1-1.5 mol %) and included some clusters in the narrow region of Pb²⁺ concentration, leading a maximum blue color coordinate to (0.13, 0.17). Provided that the Pb concentration become larger than 4.0 mol %, the crystalline characteristic of the host material is deteriorated and the luminance is largely decreased.

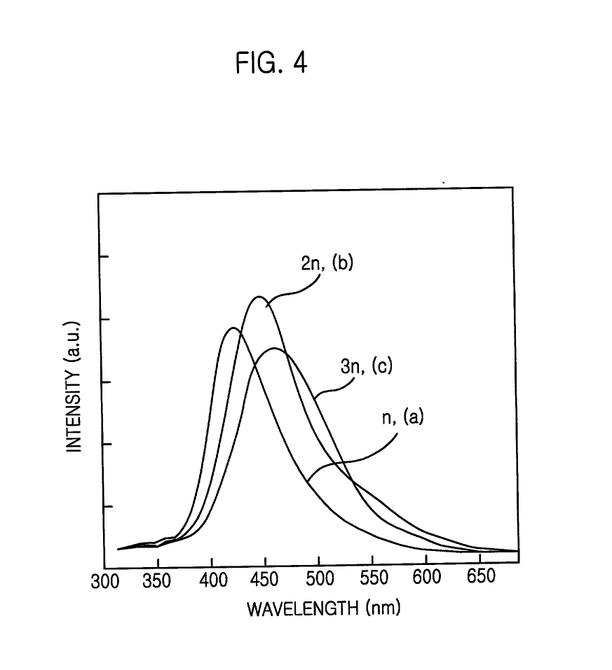

Meanwhile, FIG. 4 shows the characteristics of the phosphor thin film fabricated with maintaining the growth cycle number of CaS and changing an amount of PbS doped per cycle, i.e., the thickness of PbS doped into the host material CaS. In FIG. 4, (b) is an EL spectrum of a CaS:Pb phosphor grown at 350° C. with 2 times as a thickness of PbS as (a). (c) is the case of 3 times as the thickness of PbS as (a). As shown in FIG. 4, the longer the thickness of PbS is, the longer wavelength the peak position of the EL spectrum moves to and, further, the wider the width of the peak becomes. These results are also shown by the CIE color coordinate. Table 2 shows the changes of the concentration and CIE color coordinate according to the change of the growth cycle number of PbS. The increase of “y” value in the CIE color coordinate indirectly shows the movement of the peak to a longer wavelength. Here, the “x” value is the red-included ratio and the “y” value is the green-included ratio. The blue included ratio corresponds to 1-x-y. Therefore, it means that the smaller the x and y values are, the more excellent the purity of blue color is. As shown in Table 2, the color purity of the luminescence emitted from the CaS:Pb phosphor is affected by the cycle number of PbS growth. Furthermore, if the growth thickness of PbS is controlled even in the condition of a certain Pb concentration of below 0.1 mol %, the luminescence of green region is generated.

TABLE 2

| | | |
|---|---|---|
| Pb | “b” | |
| concen- | (No. of | |
| tration | cycles of | CIE color coordinate |

| (mol %) | PbS growth) | x | y |
|---|---|---|---|
| 0.5 | 2 | 0.16 | 0.13 |
| 1.0 | 4 | 0.17 | 0.19 |
| 1.5 | 6 | 0.16 | 0.25 |

The results shown in FIGS. 3 and 4, and Tables 1 and 2 show that the color coordinate of the CaS:Pb phosphor is not simply determined by the Pb concentration, but is determined by the state of Pb²⁺ ions. When the cycle number of PbS addition at one time is 4 or less, blue light better than (0.17, 0.19) can be obtained at a temperature of 350° C. or higher, e.g., 500° C. These results are very consistent with the “quantum dot effect” that the smaller the particle of semiconductor materials in a nanometer scale is, the larger the band gap is, so that the band gap can be controlled by the particle size.

These results show that the present invention can substantially manufacture an MX:Pb²⁺ (M=Ca, Sr, Ba, Zn or Mg; X=S or Se) compound including a specific form of Pb²⁺ ions regardless of the total concentration of Pb. In accordance with an embodiment of the present invention, the CaS:Pb blue EL phosphor emitting the luminescence with a specific wavelength could be manufactured through the surface reaction regardless of the Pb concentration by controlling the growth thickness of PbS, i.e., the growth cycle number of PbS at a growth temperature of 350 to 400° C.

In view of the state of the Pb-precursor and convenience in the fabrication, the coordination compounds mainly used in the fabrication of PbS and PbO thin films in the prior arts are solid, while the present invention uses the tetraalkyl lead precursor in a liquid state in forming the PbX film. Therefore, the present invention provides an advantage that liquid source materials are easily injected into a manufacturing equipment and, thus, the present invention can save source materials and reduce production cost. Moreover, since the Pb-precursor has stable reactivity, the present invention shows good characteristics in the thickness uniformity of the thin film and the reproducibility of the fabricating processes. In addition, the Pb-precursor used in the present invention does not include oxygen, which is easily bonded with Pb.

It is possible that the method of manufacturing the phosphor can be applied to the fabrication of the CL phosphor as described in the above.

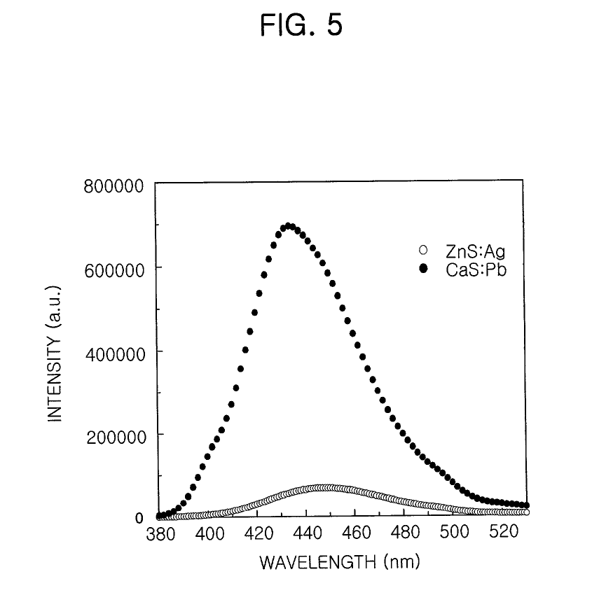

FIG. 5 shows a spectrum comparing a CL peak of CaS:Pb phosphor with a 0.7 at. % Pb²⁺ ion concentration and a thickness 500 Å and formed by using the tetraethyl lead with that of a conventional ZnS:Ag phosphor. The maximum wavelength of the CL peak of the CaS:Pb phosphor is within a range of approximately 435 nm to 440 nm and the intensity of the CaS:Pb phosphor shows at least 7 times larger than that of ZnS:Ag powder, which is a commercially available blue phosphor of CRT.

Meanwhile, since the Pb²⁺ ion has the 6S² valence electron structure as afore-mentioned, it is much affected by the state of the MX host material. Therefore, as the crystalline state of the host material is changed according to the growth temperature, the wavelength movement occurs more or less with the change of the reaction temperature. However, the degree of the wavelength movement is not very large compared to the change of the growth thickness of PbS per cycle.

The results described as above are contrary to the trend to change the color continuously from ultraviolet through blue to green according to the increase of the Pb concentration in the prior arts. So far, no research shows the above technology which uses the Pb²⁺ ions as light-emitting center ions and, at the same time, grows the phosphor as adjusting the color.

In the method of the prior patent document (U.S. Pat. No. 5,314,759) to grow a ZnS:Tb green EL phosphor by using the atomic layer deposition in association with the thickness of a light-emitting region including light-emitting center ions, the patent document asserted that if the light-emitting layer was thicker, i.e., the growth thickness of Tb₂S₃ layer as described above was longer, that is very advantageous in obtaining the high luminance. However, in accordance with the present invention, as shown in Table 2, when the growth thickness of Pb²⁺ ions is larger, the clustering of Pb²⁺ ions deteriorates the color purity of the phosphor. So, the present invention shows that the shorter growth thickness is advantageous in obtaining the blue emission with the high luminance. That is, it is more advantageous to obtain the blue emission to adjust the amount of PbS to form no connected film state and to prevent a dimer from being neighbor to other dimers.

The phosphor material of the present invention that selectively generates light-emission only by the Pb²⁺ dimer cannot be manufactured by using physical deposition methods such as a conventional heat-treatment method for the mixture powder, a sputtering deposition method and an electron beam deposition. The phosphor used in the present invention, which can mostly emit only blue luminescence without emission of ultraviolet or green by selectively and dominantly containing the dimer state of Pb²⁺ ion, exhibits a good characteristic when it can be manufactured only by controlling the growth rate of PbX to be below 1 monolayer/cycle, preferably, below 0.2 monolayer/cycle or 0.005 to 0.6 Å/cycle.

As described above, it is also very important to control the growth thickness, i.e., growth cycles, of PbX. If the growth thickness increases, the growth rate of PbX also does. This means that a sticking coefficient of the Pb-precursor is larger on PbX than on CaX. In a condition of the growth temperature of 350° C., the X-ray diffraction (XRD) data begin to show a metallic Pb peak, and the amount of the metallic Pb increases as the growth temperature becomes higher. However, at the time of controlling the growth thickness of PbX to be as low as possible, the metallic lead peak is never observed even in the condition of above 420° C., in which the metallic lead peak easily occurs. This shows that it is very important to control the growth thickness of PbX to be thin.

The growth rate is various according to the kind of the precursor used in the growth reaction system. This is also one of important variables. For example, when Pb(thd)₂ was used as a Pb-precursor for growing a CaS:Pb phosphor, the growth rate was higher 10 times than that of a tetraethyl lead at a temperature of 300-350° C. In this case, the blue EL phosphor with excellent color purity could not be obtained, and its luminance was also very low.

As another example of controlling the color of luminescence using the growth rate, in case of a SrS:Pb phosphor, ultraviolet is emitted at the presence of Pb monomer and green luminescence is emitted at the presence of Pb dimer. Therefore, the experimental results mean that when the SrS:Pb phosphor is selectively grown with the dimer state of Pb²⁺ ion, the green phosphor emitting luminescence at a wavelength of near 500 nm can be selectively manufactured. The present invention is contrary to the prior arts, in which luminescence with near white color is emitted in the wide wavelength range when the concentration of Pb increases.

The phosphor manufactured in accordance with the present invention can be used in an electroluminescent device and a cathodeluminescence device as a phosphor with high color purity and high luminance.

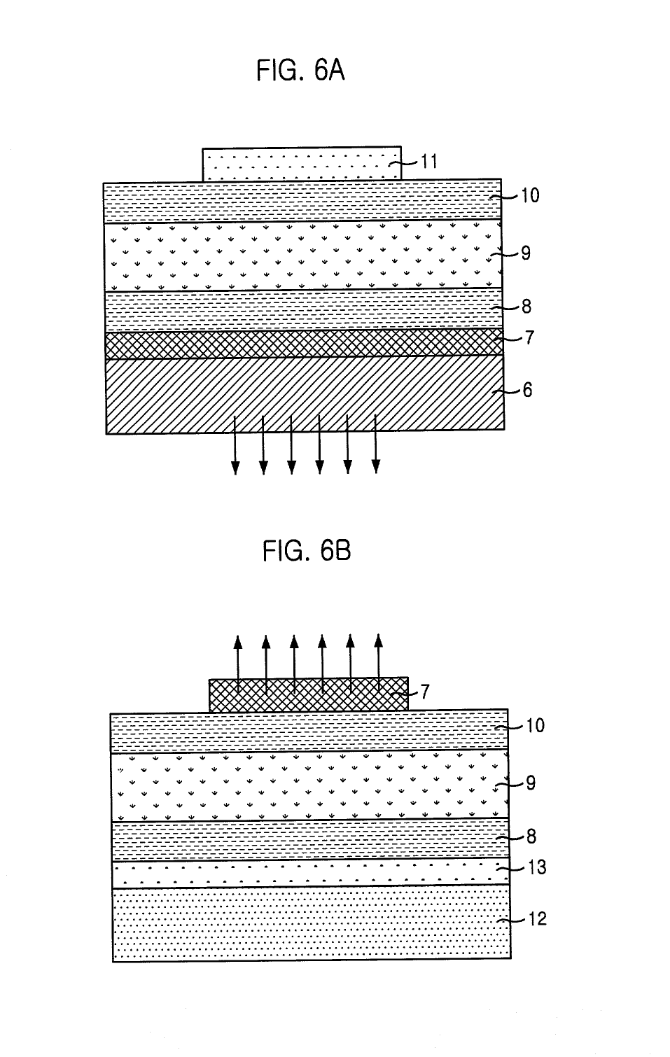

FIGS. 6A and 6B show structures of an alternating current driven thin film electroluminescent device (AC-TFELD) grown on a transparent substrate and an inverted structure grown on a non-transparent substrate, respectively.

FIG. 6A is a general form of an electroluminescent device and FIG. 6B shows a representative structure of an active matrix thin film electroluminescent device.

Referring to FIG. 6A, the alternating current driven thin film electroluminescent device (AC-TFELD) has a double insulating structure. A transparent conductive thin film such as ITO (Indium Tin Oxide) or ZnO:Al (aluminum doped zinc oxide) is formed as a transparent electrode 7, on a transparent substrate 6 such as glass and borosilicate glass. A lower insulating layer 8 is then formed on the transparent electrode 7. Subsequently, on the lower insulating layer 8 is formed a phosphor thin film 9 including Pb²⁺ light-emitting center ions doped by the method in accordance with the present invention. An upper insulating layer 10 is then formed on the phosphor film 9. A metal electrode 11 such as Al, Au and W is formed on the upper insulating layer 10. Therefore, in this device, the phosphor thin film 9 is inserted between the lower and upper insulating layers 8 and 10. These insulating layers allow a high electric field to be applied into the phosphor film 9 and play a role to protect the film 9 from the external environment.

Referring to FIG. 6B, in the invert structure of the active matrix thin film electroluminescent device, a layer of fire-durable metal 13 such as W and Mo is formed as a metal electrode on a non-transparent substrate 12 such as silicon and alumina. A first insulating layer 8 is then formed on the metal electrode 13. Subsequently, on the first insulating layer 8 is formed a phosphor thin film 9 including Pb²⁺ light-emitting center ion manufactured by the method of the present invention. A second insulating layer 10 is then formed on the phosphor thin film 9. A transparent electrode 7 is then formed on the second insulating layer 10. Therefore, in this device, the luminescence is emitted from the phosphor thin film 9 through the transparent electrode 7 to the outside.

The phosphor thin film 9 is formed by using the surface saturation reaction between the Pb-precursor of a metalorganic compound and H₂X (X=S or Se) in the equipment shown in FIG. 2.

The present invention provides a method for fabricating a blue phosphor layer with high luminance needed to accomplish full colors in the technical field of the alternating current driven thin film electroluminescent device (AC-TFELD). The present invention can also fabricate the blue active matrix thin film electroluminescent device. The present invention can also provide the natural color electroluminescent device by applying the phosphor thin film 9 to one of three original color phosphor films. The present invention can also use the phosphor thin film as one of white phosphor films and allow the electroluminescent device to emit the luminescence of natural color by filtering the luminescence of white color.

The PbS thin film of the present invention may be utilized to a solar cell, an infrared detector and the like as well as the electroluminescent device.

Particularly, the present invention can provide a very uniform PbX thin film applicable even to a large-scale substrate such as a 12″×16″ substrate.

The growth of quantitative PbX in the present invention was verified by a Rutherford backscattering spectrometry (RBS) analysis. The RBS data showed that a composition ratio of Pb and S was approximately 1:1. Further, it is verified by using an X-ray diffraction (XRD) method that a polycrystalline PbX thin film grown on an amorphous thin film had a cubic crystalline structure, which is a well-known crystalline structure. Although the PbX thin film used in the analyses of RBS and XRD was very thin, a clear XRD peak appeared, representing that the grown PbS had good crystallinity.

In the structure of the electroluminescent device in accordance with another embodiment of the present invention, the phosphor layer may be formed as a multi-layer structure, which includes at least two kinds of thin layers of the host material selected from a group consisting of CaS, SrS, ZnS, BaS and MgS. Since the polycrystalline thin films of CaS, SrS, ZnS, BaS and MgS have all cubic structure, particularly ZnS, which is excellent in the crystalline property, plays a role of enhancing the crystalline property of the neighboring film and a role of limiting the overflow of charge. The PbS may be doped into all or some of layers of only one kind of host material among all layers. The PbS may be also doped homogeneously into all layers of the used host material.

The method of the present invention inserts the PbX (X=S or Se) into the host material through the surface reaction between the metalorganic compound precursor and H₂X by using one of the traveling wave reactor type atomic layer deposition shown in FIG. 2, a chemical vapor deposition and an atomic layer deposition using a compound beam. The method also grows the phosphor film as described above by using the atomic layer deposition or chemical vapor deposition. The phosphor film is applied to a device such as the EL device and CL device.

The present invention provides the method for growing the PbX thin film by using the atomic layer deposition or chemical vapor deposition using the reaction of H₂X with the Pb-precursor having a 4-covalent bond. It can also grow the phosphor thin film by performing the processes for growing the host material layer of II-VI compound semiconductor such as CaS, CaSe, SrS, SrSe, ZnS, ZnSe, BaS, BaSe, MgS and MgSe and performing the processes for growing a IV-VI compound such as PbX between the processes for growing the host material layer at some intervals, wherein the growth of the PbX compound is achieved through the surface chemical reaction. It can also fabricate the phosphor in which the light-emitting center ions, particularly, Pb²⁺ ions selectively have the dimer state under the specific condition.

Although not described in the present invention, there are the following various examples of variation and modification in the method for fabricating the electroluminescent device.

In the ALD process for forming a polycrystalline thin film or multi-layer thin film, the host material is selected from a group consisting of Pb-doped CaS, SrS, ZnS, BaS, MgS, CaSe, SrSe, ZnSe, BaSe and MgSe and the Pb-precursor includes a tetraalkyl lead, a tetraaryl lead, tetravalent lead compounds having alkyl and aryl groups, a dicyclopentadienyl lead or bis(trialkylsilyl) lead and the like, wherein the alkyl group includes methyl, ethyl, propyl, isopropyl and cyclohexyl groups, and the aryl group includes phenyl and benzyl groups.

Further, the phosphor is formed with one or more thin films. The multi-layer structure may be formed by repeatedly growing a ZnS layer and a CaS:Pb layer at least one time; a SrS:Pb layer and a CaS:Pb layer at least one time; or a ZnS layer, a SrS:Pb layer and a CaS:Pb layer at least one time. In the multi-layer structure, a Pb(IV) metalorganic compound or Pb(II) metalorganic compound precursor can be used as the Pb-precursor.

In the phosphor of the multi-layer structure, at least one layer may be an MX (M=Ca or Sr; X=S or Se) polycrystalline thin film doped with 0.2 to 4.0 mol % of PbX. Herein, the amount of Pb corresponds to 0.1 to 2.0 at. %.

As an example, the electroluminescent devices were fabricated with a relative amount, e.g., 0.2 to 4.0 mol %, of PbS doped into CaS using the tetraethyl lead precursor. The color coordinates (x, y) of luminances emitted from the devices were 0.12 to 0.19 of x and 0.07 to 0.20 of y. The colors are near pure blue color. Particularly, when the devices were fabricated mostly with the dimer state of Pb²⁺ ions, the color of the luminescence emitted by the device was in the narrow range between (0.14, 0.07) and (0.15, 0.15). The maximum EL peak was found in the range of 440 to 450 nm. This value is the same as the blue color of the most ideal cathode ray tube. The maximum luminance was above 100 cd/m² at 60 Hz, which was several to several tens times as high as those of the devices fabricated by the prior arts.

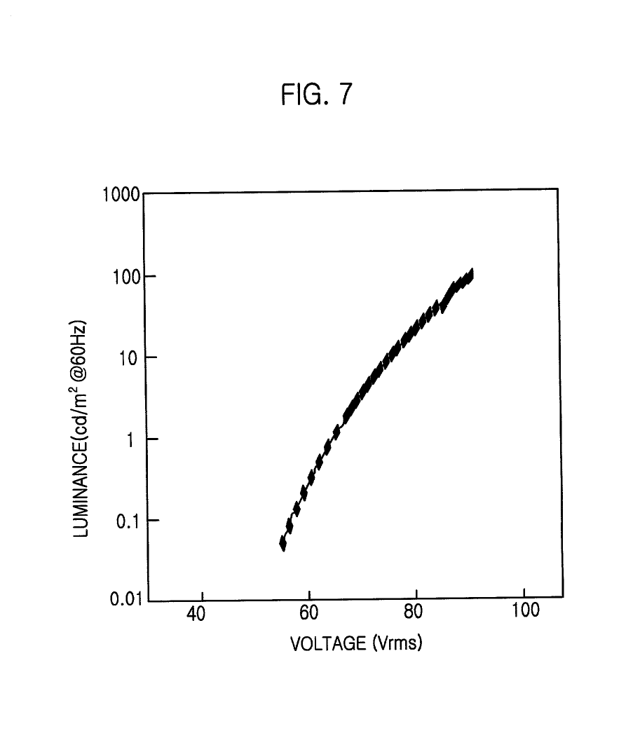

FIG. 7 shows a luminance curve of the CaS:Pb blue electroluminescent device fabricated at 400° C. by using the atomic layer deposition. In this fabrication condition, the results showed that the luminance was 85 cd/m² at a driving voltage higher as 25 V than a threshold voltage and the maximum luminance was more than the value. In the results, the color coordinate was (0.15, 0.10) near pure blue. This value of luminance is about 30 times higher than the result of E. Nykanen et al. in Finland.

The results of the EL spectra of the CaS:Pb electroluminescent device in accordance with the present invention was compared with those of the device fabricated by using thd-compound of Pb. These devices were fabricated with the same equipment and growth condition, but with the different Pb-precursors and methods for adding PbS into the host material.

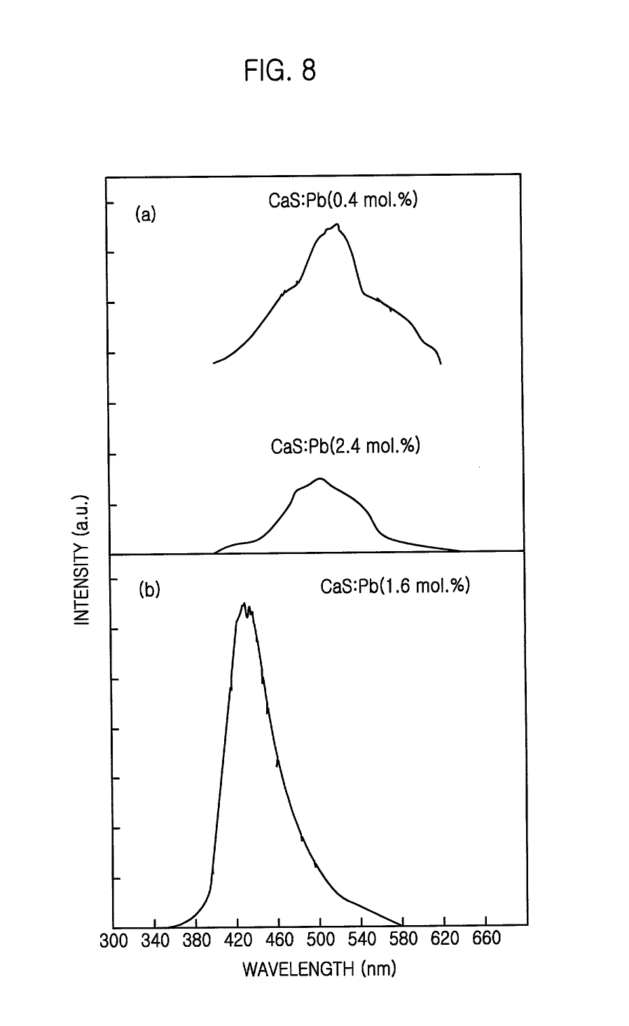

FIG. 8 shows the electroluminescent spectrum characteristics of the electroluminescent device fabricated by using thd-compound and tetraethyl lead, respectively. As shown in FIG. 8, the wavelength at the EL peak maximum value of the electroluminescent device fabricated by using the tetraethyl lead is in a range of 440 nm to 445 nm, and the full width at half maximum is narrower than 60 nm. However, the peaks in the spectrum of the device fabricated by using Pb(thd)₂ are so wide and exist in the longer wavelength range.

The present invention is also applicable to depositing a Pb²⁺ ion-containing phosphor layer, which contains other ions as codopants added in order to improve the luminance characteristics.

While the present invention has been described with respect to certain preferred embodiments only, other modifications and variations may be made without departing from the spirit and scope of the present invention as set forth in the following claims.

What is claimed is:

1. A method of fabricating a phosphor, comprising the steps of:
growing a host material of MX including a II group element (M=Ca, Sr, Zn, Ba or Mg) and a VI group element (X=S or Se) by reacting an M-precursor with a compound including the VI group element; and
adding Pb²⁺ ions into the host material as light-emitting center ions by forming a PbX thin film through a surface saturation reaction between a Pb-precursor and H₂X at a reaction temperature higher than a decomposition temperature of the Pb-precursor, wherein the Pb-precursor is a metalorganic compound in which Pb is covalent-bonded with an organic functional group.

2. The method according to claim 1, wherein the metalorganic compound is selected from a group consisting of a tetraalkyl lead, a tetraaryl lead, an alkylaryl lead, a dicyclopentadienyl lead and a bis (trialkylsilyl) lead.

3. The method according to claim 2, wherein the alkyl group or the aryl group of the tetraalkyl lead, the tetraaryl lead, the alkylaryl lead and bis (trialkylsilyl) lead is selected from a group consisting of methyl, ethyl, propyl, isopropyl, cyclohexyl, phenyl and benzyl.

4. The method according to claim 1, wherein the concentration of Pb²⁺ in the phosphor is in a range of PbX of about 0.2 mol % to about 4.0 mol %.

5. The method according to claim 1, wherein the host material growing step and the PbX adding step are simultaneously performed and the concentration of Pb²⁺ is adjusted by a ratio of the concentration of the M-precursor to that of the Pb-precursor.

6. The method according to claim 1, wherein the host material growing step performed more than one cycle and the PbX adding step are alternately repeated to form the phosphor having a desired thickness.

7. The method according to claim 6, wherein the adding rate of the PbX is 0.005 to 0.6 Å/cycle.

8. The method according to claim 7, wherein the PbX adding step is executed four or less cycles at one time.

9. The method according to claim 1, wherein, in case the Pb-precursor is a tetraethyl lead, the reaction temperature is in a range of about 150° C. to about 500° C.

10. The method according to claim 9, wherein the PbX adding step is executed four or less cycles at one time at the reaction temperature ranging from about 350° C. to about 500° C.
